(19) United States
(12) Patent Application Publication
(10) Pub. No.: US 2013/0049515 A1
(43) Pub. Date: Feb. 28, 2013

(54) STATOR FOR ROTARY ELECTRIC MACHINE, AND ROTARY ELECTRIC MACHINE

(71) Applicants: Tomokazu Hisada, Anjo-shi (JP); Ryosuke Utaka, Takahama-shi (JP); Naoto Koshino, Toyota-shi (JP); Yoshiyuki Kawasaki, Takahama-shi (JP); Norimoto Minoshima, Kariya-shi (JP); Taketo Takeuchi, Nishio-shi (JP)

(72) Inventors: Tomokazu Hisada, Anjo-shi (JP); Ryosuke Utaka, Takahama-shi (JP); Naoto Koshino, Toyota-shi (JP); Yoshiyuki Kawasaki, Takahama-shi (JP); Norimoto Minoshima, Kariya-shi (JP); Taketo Takeuchi, Nishio-shi (JP)

(73) Assignee: TOYOTA JIDOSHA KABUSHIKI KAISHA, Toyota-shi, Aichi-ken (JP)

(21) Appl. No.: 13/639,205

(22) PCT Filed: Apr. 5, 2011
(86) PCT No.: PCT/IB2011/000732

§ 371 Date: Nov. 7, 2012

(30) Foreign Application Priority Data
Apr. 6, 2010 (JP) 2010-087966

(51) Int. Cl. H02K 3/12; H02K 3/48

(52) U.S. Cl. 310/198

(57) ABSTRACT

A stator includes a stator core, a stator winding, and insulation paper sheets. The stator winding is constructed by forming a Y connection of phase windings each of which is constructed by inserting conductor segments into slots from a lower end side of the stator core and joining distal end portions of the conductor segments which protrude from an upper end side of the stator core. One of the insulation paper sheets is disposed between radially adjacent ones of joint portions that constitute a group of joint portions in a U-phase winding that are the nearest to a U-phase terminal. In the same manner, the other insulation paper sheets are disposed with respect to a V-phase winding and a W-phase winding. Surfaces of the other joint portions are covered with an insulation resin. Insulation paper sheets are disposed between joint portions that need long creepage distances and the insulation resin is used to cover surfaces of the other joint portions that do not need a long creepage distance.

### BACKGROUND OF THE INVENTION

1. Field of the Invention

The invention relates to a stator for a rotary electric machine which is equipped with stator windings constructed by joining distal end portions of a plurality of U-shape conductor segments, and also relates to a rotary electric machine.

2. Description of Related Art

Examples of a stator for a rotary electric machine which is equipped with stator windings constructed by joining distal end portions of a plurality of U-shape conductor segments are alternating-current electricity generators for a vehicle that are disclosed in Japanese Patent Application Publication No. 2000-278901 and Japanese Patent Application Publication No. 2000-209802.

Each of the vehicular alternating-current electricity generators disclosed in Japanese Patent Application Publication No. 2000-278901 (JP-A-2000-278901) and Japanese Patent Application Publication No. 2000-209802 (JP-A-2000-209802) includes a stator that has a stator iron core and a stator winding. The stator iron core has a plurality of slots that extend through the stator iron core from one end side to another end side. The stator winding is constructed by inserting leg portions of the U-shape conductor segments into the slots from the one end side of the stator ion core, and joining distal end portions of the conductor segments that protrude from the other end side of the stator iron core.

In the alternating-current electricity generator for a vehicle described in Japanese Patent Application Publication No. 2000-278901 (JP-A-2000-278901), the joint portions of the conductor segments are covered with an electrical isolation resin.

On the other hand, the alternating-current electricity generator for a vehicle described in Japanese Patent Application Publication No. 2000-209802 (JP-A-2000-209802) is equipped with a cap that has two annular chambers that are formed side by side. The two adjacent chambers are filled with an electrical insulation resin. Radially inner joint portions of the conductor segments are housed within the radially inner one of the two chambers of the cap, and are buried in the insulation resin. Besides, radially outer joint portions of the conductor segments are housed within the radially outer chamber of the cap, and are buried in the insulation resin. Due to the chambers of the cap and the resin, electrical insulation can be achieved between the joint portions.

As described above, in the alternating-current electricity generator for a vehicle described in Japanese Patent Application Publication No. 2000-278901 (JP-A-2000-278901), all the joint portions are covered integrally with the insulation resin. In the case where the joint portions are arranged not only in the circumferential direction but also in radial directions, the radially adjacent joint portions, whose interval is relatively short, are interlinked by the insulation resin. If a pinhole should be formed in the insulation resin that interlinks the radially adjacent joint portions, the joint portions become interconnected by the pinhole. In this case, the creepage distance reduces. Therefore, it becomes impossible to secure good creepage distances between the joint portions that are adjacent to each other in the radial direction.

On the other hand, in the alternating-current electricity generator for a vehicle described in Japanese Patent Application Publication No. 2000-209802 (JP-A-2000-209802), all the joint portions are covered with the insulation resin. Furthermore, the joint portions are integrally covered by the cap. A partition wall of the cap is disposed between joint portions that are radially adjacent to each other. Therefore, even if a pinhole should be formed in the insulation resin, the partition wall of the cap secures good creepage distances between the radially adjacent joint portions. However, the need for the cap that integrally covers all the joint portions makes it difficult to restrain the cost.

### SUMMARY OF THE INVENTION

The invention, made in view of the foregoing circumstances, provides a stator for a rotary electric machine which is able to restrain the cost and secure good creepage distances.

The present inventors, after doing vigorous study and research and making trials and errors in order to solve the foregoing task, focused attention on a fact that the necessary creepage distance becomes longer the greater the electric potential between joint portions, and have accomplished the invention on the basis of an idea that if a predetermined number of joint portions in each phase winding which are the nearest to a corresponding one of the phase terminals and which therefore have great inter-joint portion potential differences are provided with an insulation paper sheet disposed between the joint portions, and surfaces of the other joint portions are covered with an insulation resin, it becomes possible to simplify the construction and restrain the cost while securing necessary creepage distances.

According to one aspect of the invention, there is provided a stator for a rotary electric machine which includes: a stator core that has a plurality of slots that extend from one end side of the stator core to another end side of the stator core; and a stator winding constructed by forming a star connection of a plurality of phase windings that are constructed by inserting leg portions of a plurality of U-shape conductor segments into the plurality of slots from the one end side of the stator core, and joining distal end portions of the plurality of conductor segments which protrude from the other end side of the stator core, the stator being characterized in that a plurality of joint portions formed by joining the distal end portions of the conductor segments of each of the phase windings are arranged in a circumferential direction and are sequentially arranged in a radial direction from a side that is relatively near to a corresponding one of phase terminals of the phase windings, and only a predetermined number of the joint portions in each phase winding that are nearest to a corresponding one of the phase terminals among the joint portions of the phase winding are provided with an electrical insulation paper sheet that is disposed between radially adjacent ones of the predetermined number of the joint portions.

When voltage in a pulse form is applied to the stator winding in order to drive the rotary electric machine, surge voltage occurs immediately following the application of the voltage. This surge voltage occurs because of the inductance of the stator winding. Therefore, the magnitude of the surge voltage varies depending on the location along each phase winding. In a stator winding constructed by the star connection of a plurality of phase windings, the magnitude of the surge voltage gradually increases from a neutral point toward each of the phase terminals.

By the way, the creepage distance between joint portions has to be made longer the greater the potential difference between the joint portions becomes. Therefore, in the stator winding constructed by the star connection of the phase windings, the creepage distance between joint portions of each phase winding needs to be made longer the nearer to the corresponding phase terminal the joint portions are.

However, according to the foregoing construction, the predetermined number of joint portions in each phase winding that are the nearest to the corresponding one of the phase terminals and that therefore need long creepage distances are provided with an electrical insulation paper sheet that is disposed between joint portions that are adjacent to each other in the radial direction and that are apart from each other only by a short distance. That is, by disposing the insulation paper sheets between the joint portions that need long creepage distances, it becomes possible to simplify the construction of the stator and restrain the cost while securing necessary creepage distances.

In the foregoing stator for the rotary electric machine, surfaces of the joint portions other than the predetermined number of the joint portions in each phase winding that are the nearest to the corresponding one of the phase terminals may be covered with an insulation resin. According to this construction, as for the joint portions which are other than the predetermined number of the joint portions in each, phase winding that are the nearest to the corresponding phase terminal, and which have relatively small inter-joint portion potential differences and therefore do not need very long creepage distances, surfaces of these joint portions are covered with the insulation resin. That is, because the insulation paper sheets are disposed between the joint portions that need long creepage distances and the insulation resin is used to cover surfaces of the other joint portions, which do not need such long creepage distances, it is possible to simplify the construction and restrain the cost while securing necessary creepage distances.

Besides, in the foregoing stator for the rotary electric machine, surfaces of the predetermined number of the joint portions of each phase winding that are the nearest to the corresponding one of the phase terminals may be covered with the insulation resin. According to this construction, the electrical insulation characteristic of the joint portions can be improved.

Besides, in the stator for the rotary electric machine, surfaces of the predetermined number of the joint portions of each phase winding that are the nearest to the corresponding one of the phase terminals may be covered with the insulation resin besides the insulation paper sheet that is disposed between the radially adjacent ones of the predetermined number of the joint portions. According to this construction, it is possible to improve the insulation characteristic of the joint portions and certainly fix the insulation paper sheets by the insulation resin.

Besides, in the stator for the rotary electric machine, the predetermined number of the joint portions of each phase winding that are the nearest to the corresponding one of the phase terminals may be the joint portions that constitute a group of joint portions arranged in a radial direction which is the nearest to the corresponding one of the phase terminals among a plurality of groups of radially arranged joint portions in each phase winding. According to this construction, it is appropriate to dispose an insulation paper sheet only between the joint portions that constitute a group of joint portions that, among the groups thereof in each phase winding, is the nearest to the corresponding one of the phase terminals. Therefore, the assembly process can be simplified, and the cost can be further restrained.

Besides, in the foregoing stator for the rotary electric machine, the insulation paper sheet may have a generally U-shape form, and may be disposed between the joint portions. According to this construction, the insulation paper sheets can be certainly disposed between joint portions that are radially adjacent to each other.

Besides, in the stator for the. rotary electric machine, the insulation paper sheet may have a meander form, and may be disposed in a meander manner between the joint portions. According to this construction, the insulation paper sheet can be certainly disposed between joint portions that are radially adjacent to each other. Besides, since each insulation paper sheet is disposed in a meander manner between the joint portions, it is possible to substantially prevent each insulation paper sheet from falling apart in the circumferential direction.

Besides, in the stator for the rotary electric machine, the insulation paper sheet may be given the meander form by passing the insulation paper sheet between toothed wheels that rotate in mesh with each other. According to this construction, each insulation paper sheet can be certainly bent into the meander form.

Besides, in the foregoing stator for the rotary electric machine, the insulation paper sheet may be given the meander form by disposing the insulation paper sheet between two rows of rod-shape members that are arranged in a zigzag manner, and then relatively moving one of the two rows of the rod-shape members to a side of another one of the two rows of the rod-shape members. According to this construction, each insulation paper sheet can be certainly bent into the meander form.

Furthermore, according to another aspect of the invention, there is provided a rotary electric machine that is constructed by using the stator described above. According to this construction, this rotary electric machine will restrain the cost, and will certainly secure good creepage distances.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a motor-generator in the first embodiment that is taken on a plane in the direction of an axis of a motor-generator in a first embodiment of the invention;

FIG. 2 is a perspective view of a stator in a state that precedes a process of electrically insulating joint portions of conductor segments in the first embodiment;

FIG. 3 is a perspective view of one of the conductor segments;

FIG. 4 is a connection diagram of phase windings of the stator in the first embodiment;

FIG. 5 is a connection diagram of a first U-phase winding of the stator of the first embodiment;

FIG. 6 is a connection diagram of a second U-phase winding of the stator of the first embodiment;

FIG. 7 is a connection diagram of a third U-phase winding of the stator of the first embodiment;

FIG. 8 is a connection diagram of a fourth U-phase winding of the stator of the first embodiment;

FIG. 9 is an illustrative diagram for describing a process of forming bends of an insulation paper sheet;

FIG. 10 is a perspective view of the insulation paper sheet that has been subjected to the bend forming by the process shown in FIG. 9;

FIG. 11 is a partial perspective view of the stator of the first embodiment;

FIG. 12 is an enlarged partial perspective view of a stator in accordance with a modification of the first embodiment;

FIGS. 13A and 13B are illustrative diagrams for describing another bend forming process for an insulation paper sheet;

FIG. 14 is a perspective view of the insulation paper sheet that has been subjected the bend forming by the process shown in FIGS. 13A and 13B;

FIG. 15 is an illustrative diagram for describing a bend forming process for insulation paper sheets in a second embodiment of the invention; and

FIG. 16 is a partial perspective view of a stator in accordance with the second embodiment.

### DETAILED DESCRIPTION OF EMBODIMENTS

The invention will now be described more in more details with reference to embodiments. Examples in which a stator for a rotary electric machine in accordance with the invention is applied to a motor-generator that is mounted in a vehicle will be shown.

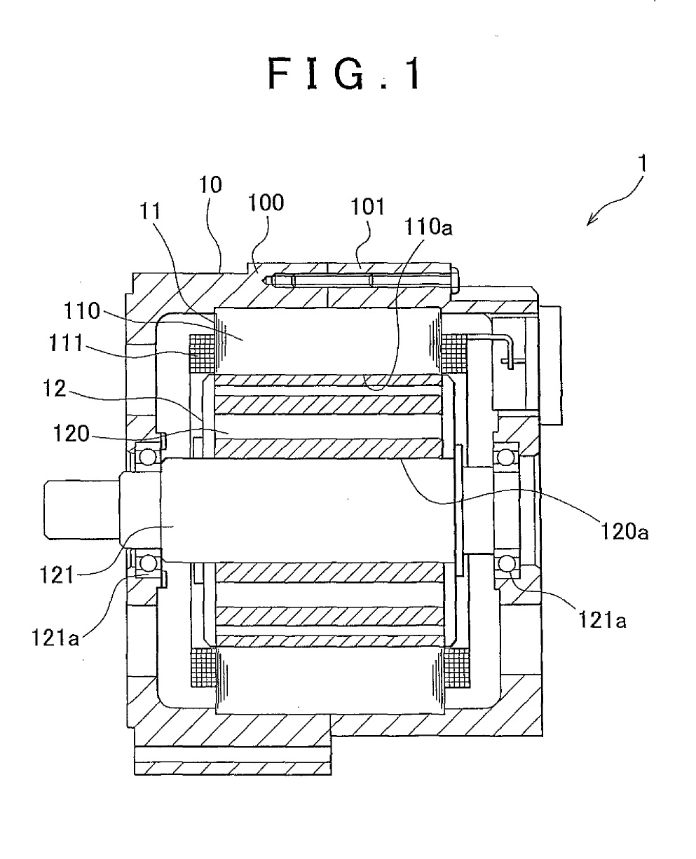

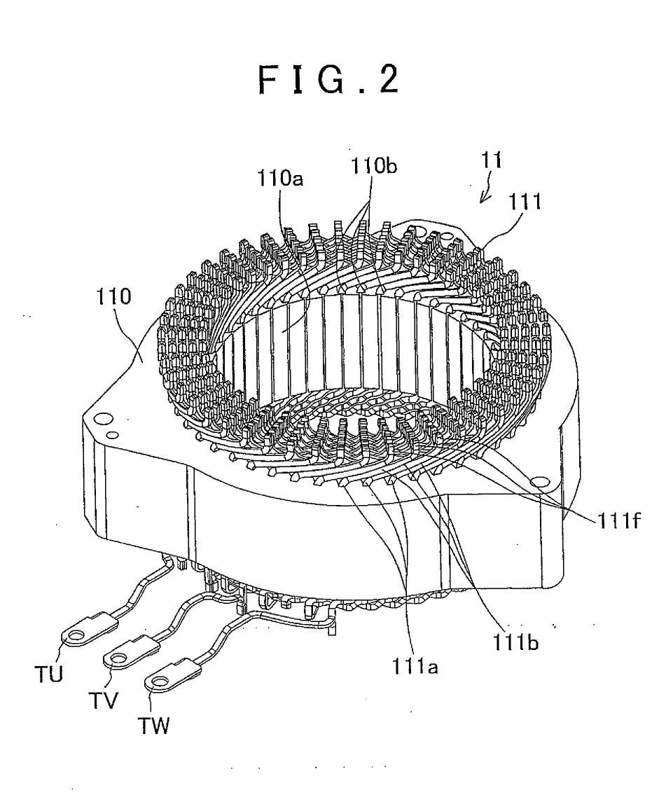

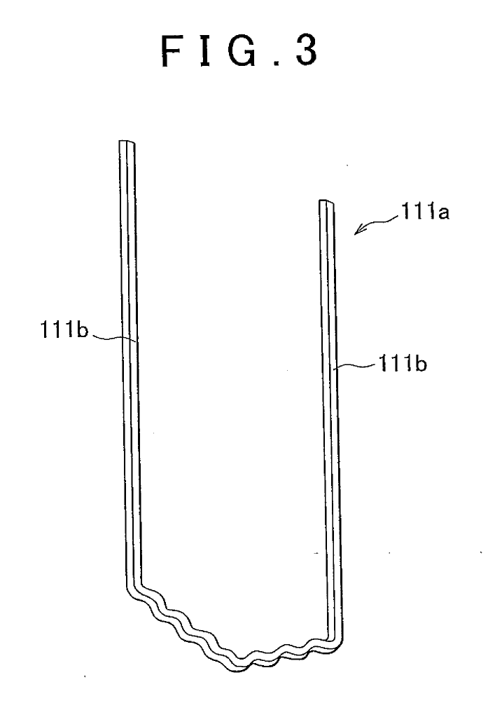

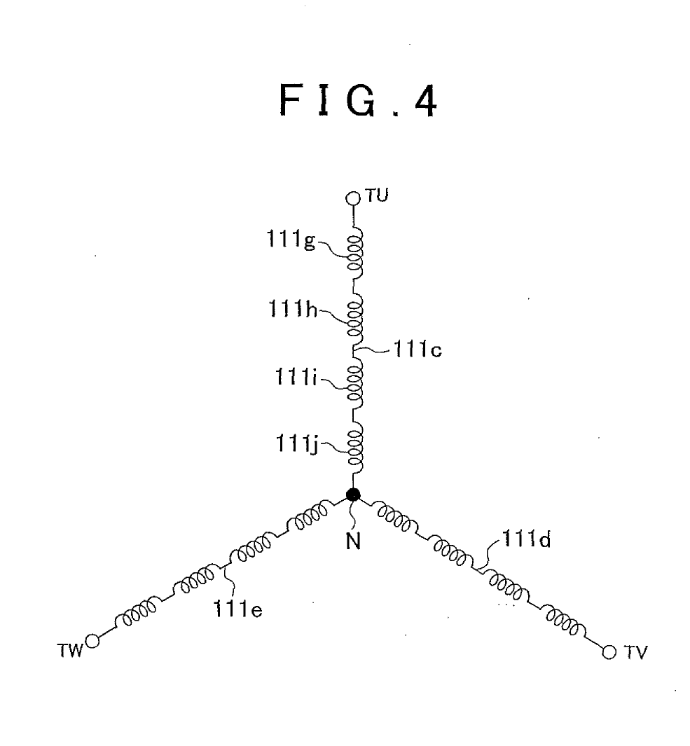

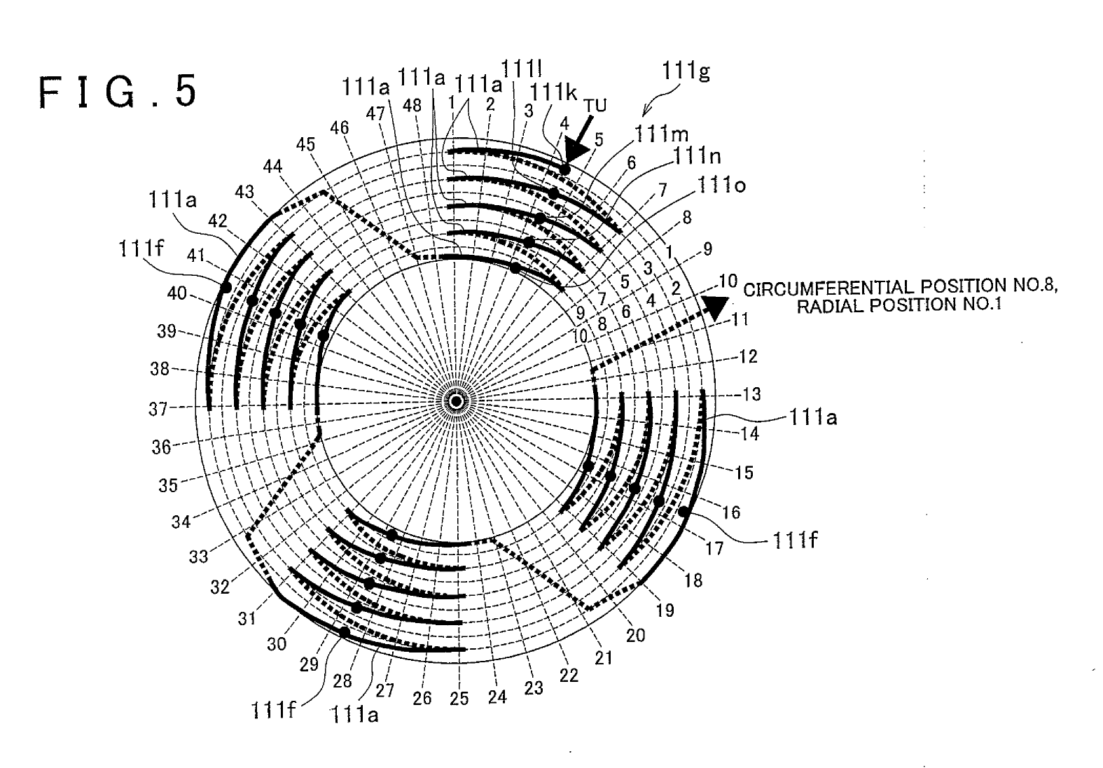

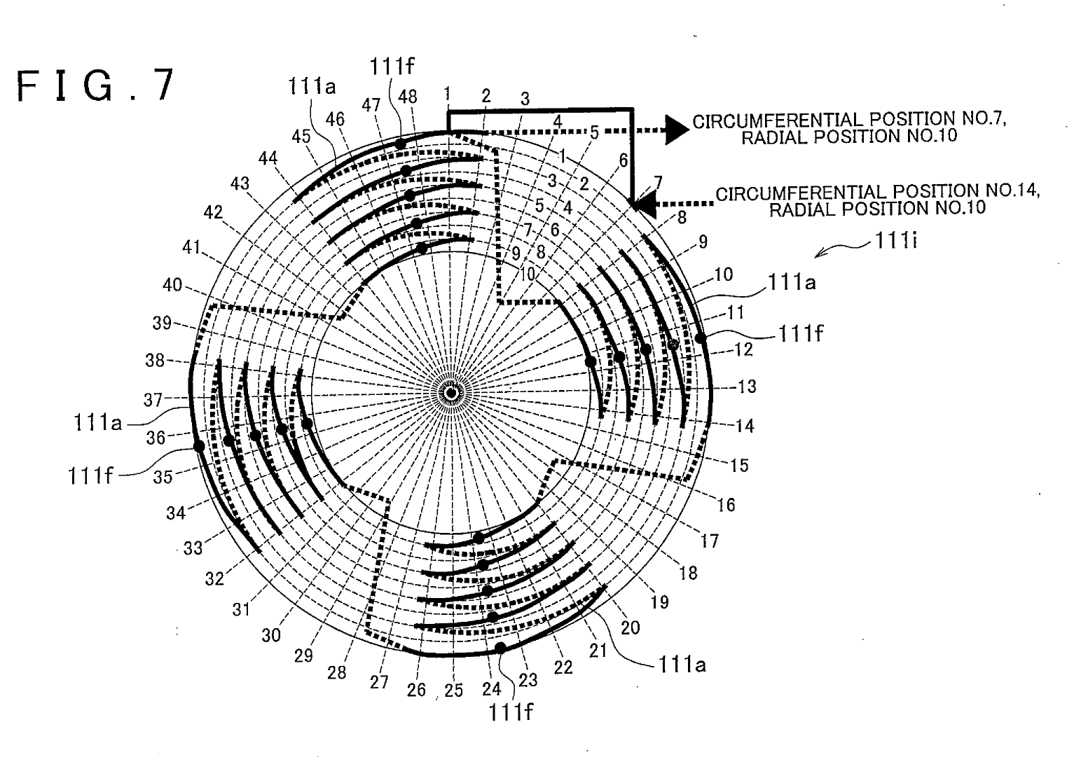

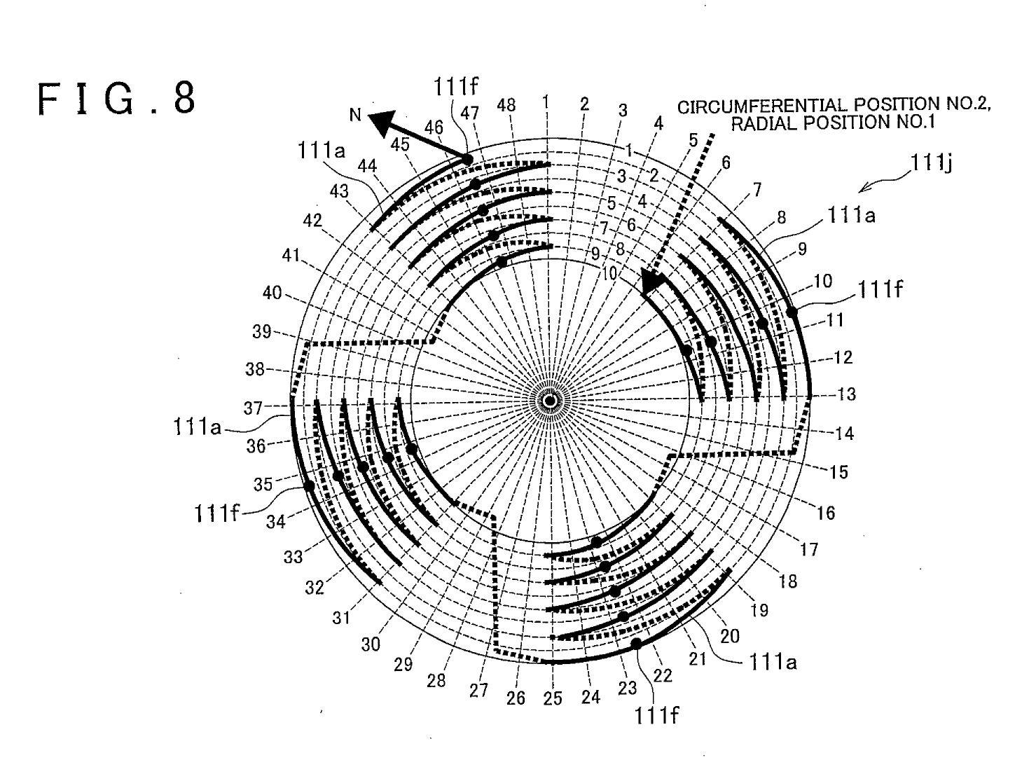

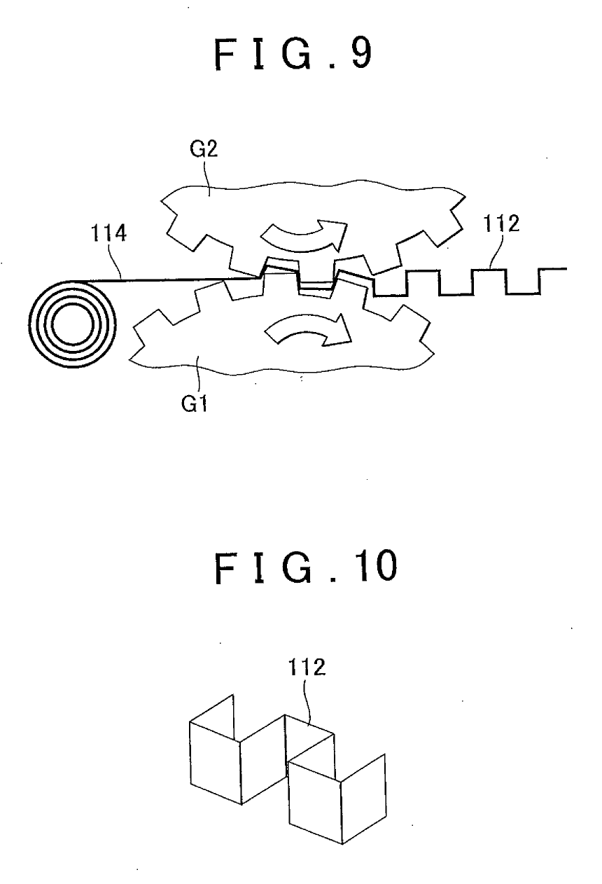

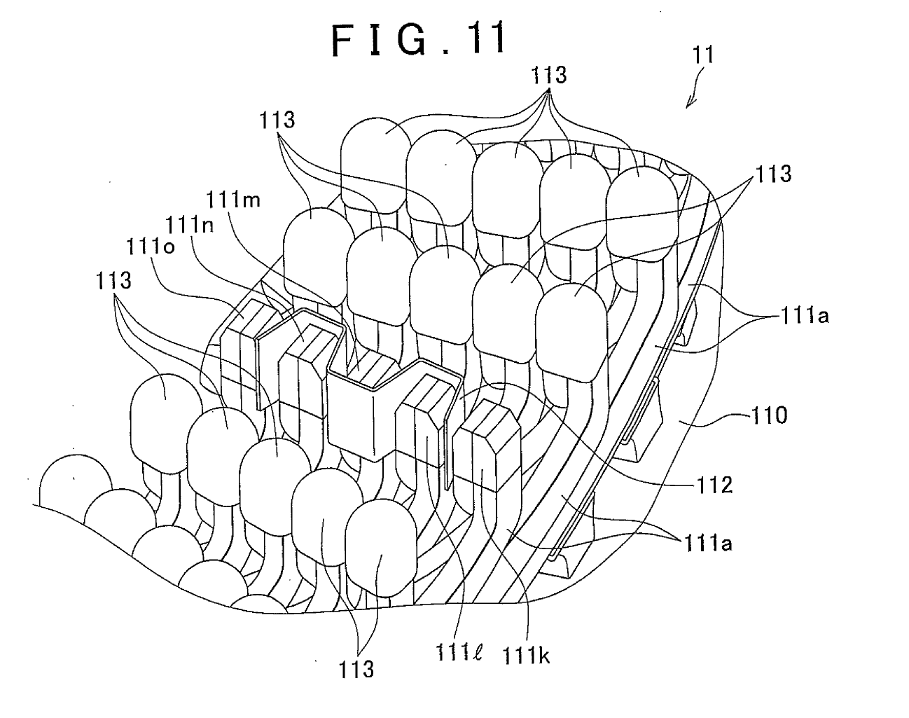

Firstly, a construction of a rotary electric machine in accordance with a first embodiment of the invention will be described with reference to FIGS. 1 to 11. FIG. 1 is a sectional view of a motor-generator in the first embodiment that is taken on a plane in the direction of an axis of a motor-generator. FIG. 2 is a perspective view of a stator in a state that precedes a process of electrically insulating joint portions of conductor segments. FIG. 3 is a perspective view of a conductor segment. FIG. 4 is a connection diagram of phase windings. FIGS. 5 to 8 are connection diagrams of first to fourth U-phase windings. FIG. 9 is an illustrative diagram for describing a process of forming bends of an insulation paper sheet. FIG. 10 is a perspective view of the insulation paper sheet that has been subjected to the bend forming by the process shown in FIG. 9. FIG. 11 is a partial perspective view of the stator. Incidentally, in FIGS. 5 to 8, numbers in the circumferential direction are given to identify slots of the stator core. Numbers in a radial direction are given to identify conductor segments that are housed in each slot. For example, a combination of circumferential position No. 9 and radial position No. 5 shows the fifth conductor segment from the outer periphery side, among the conductor segments that are housed in the ninth slot (slot No. 9) in the circumferential direction. Besides, in each of FIGS. 5 to 8, thick solid lines show portions of a winding that extend on an upper end side of the stator core, and thick interrupted lines show portions of the winding that extend on a lower end side of the stator core.

As shown in FIG. 1, a motor-generator 1 includes a housing 10, a stator 11, and a rotor 12.

The housing 10 is a member that houses the stator 11 and that rotatably supports the rotor 12. The housing 10 is constructed of housing members 100 and 101 that have a generally bottomed cylinder shape. The housing 10 is constructed of joining opening portions of the housing members 100 and 101.

The stator 11 shown in FIGS. 1 and 2 is a member that constitutes a part of a magnetic path, and that generates magnetic flux when electric current flows therethrough. The stator 11 includes a stator core 110, a stator winding 111, and insulation paper sheets 112.

The stator core 110 is a columnar member that constitutes a part of the magnetic path, and that is made of a magnetic material, and that holds the stator winding 111. A center portion of the stator core 110 has a cylindrical through hole 110a that extends through the stator core 110 from one end side to another end side. Besides, a circumferential edge portion of the stator core 110 is provided with forty eight rectangular slots 110b that each extend from the one end side to the other end side of the stator core 110 and that are arranged equidistantly in the circumferential direction. The stator core 110 is fixed to an inner peripheral surface of each of the housing members 100 and 101.

The stator winding 111 is a member that generates magnetic flux when current flows therethrough. The stator winding 111 is constructed of generally U-shape conductor segments 111a as shown in FIG. 3. Each conductor segment 111a has a pair of leg portions 111b. As shown in FIG. 2, the stator winding 111 is constructed as follows. That is, the leg portions of the conductor segments 111a are inserted into the slots 110b from a lower end side (the one end side) of the stator core 110, and distal end portions of the leg portions of the conductor segments 111a which protrude from the upper end side (the other end side) of the stator core 110 are joined so as to construct a U-phase winding 111c, a V-phase winding 111d and a W-phase winding 111e (a plurality of phase windings). These phase windings are interconnected in a manner of Y-connection (star connection). As shown in FIG. 2, the joint portions 111f formed by joining the distal end portions of the conductor segments 111a are arranged in the circumferential direction on the upper end side of the stator core 110. The number of the joint portions 111f arranged in the circumferential direction on the upper end side is forty eight. Besides, in each of the radial directions, five joint portions 111f are arranged as a group in the order of nearness to a U-phase terminal TU, a V-phase terminal TV and a W-phase terminal TW (collectively termed the phase terminals).

A construction of the U-phase winding 111c will be described in detail. As shown in FIG. 4, the U-phase winding 111c is constructed by connecting first to fourth U-phase windings 111g to 111j in series. As shown in FIG. 5, the leg portions of the conductor segments 111a that constitute the first U-phase winding 111g are inserted into the slots of circumferential position Nos. 1 and 7, and the slots of circumferential position Nos. 13 and 19, and the slots of circumferential position Nos. 25 and 31, and the slots of circumferential position Nos. 37 and 43, respectively. Of the conductor segments 111a whose leg portions are inserted in the slots of circumferential Nos. 1 and 7, the conductor segment 111a whose legs are at radial position Nos. 2 and 3 (from the outer peripheral side) is connected as follows. That is, the distal end portion of the leg portion at radial position No. 2 of this conductor segment 111a is joined to a conductor that is connected to the U-phase terminal TU, forming a joint portion 111k. The distal end portion of the radial-position-No. 3 leg portion of the conductor segment 111a disposed at radial position Nos. 2 and 3 is joined to the distal end of the radial-position-No. 4 leg portion of the conductor segment 111a disposed at the radial position Nos. 4 and 5, forming a joint portion 111l on the upper end side of the stator core 110. The distal end portion of the radial-position-No. 5 leg portion of the conductor segment 111a disposed at radial position Nos. 4 and 5 is joined to the distal end of the radial-position-No. 6 leg portion of the conductor segment 111a disposed at radial position Nos. 6 and 7, forming a joint portion 111m on the upper end side of the stator core 110. The distal end portion of the radial-position-No. 7 leg portion of the conductor segment 111a disposed at radial position Nos. 6 and 7 is joined to the distal end of the radial-position-No. 8 leg portion of the conductor segment 111a disposed at radial position Nos. 8 and 9, forming a joint portion 111n on the upper end side of the stator core 110. The distal end portion of the radial-position-No. 9 leg portion of the conductor segment 111a disposed at radial position Nos. 8 and 9 is joined to the distal end of the radial-position-No. 10 leg portion of the conductor segment 111a disposed in the slots of circumferential position Nos. 1 and 43 and at radial position Nos. 10 and 1, forming a joint portion 111o on the upper end side of the stator core 110. The distal end portions of the leg portions of conductor segments 111a are joined in substantially the same manner to form the first U-phase winding 111g as shown in FIG. 5.

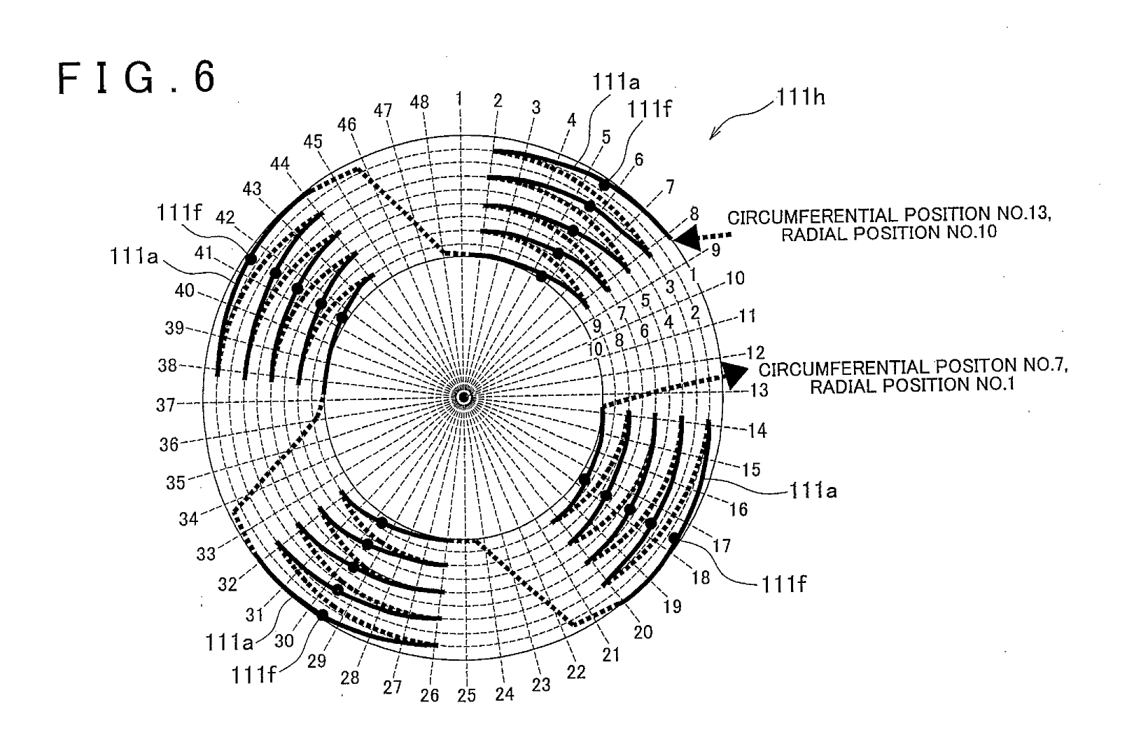

Furthermore, as shown in FIGS. 6, 7 and 8, the distal end portions of conductor segments 111a are connected in substantially the same manner as described above to form the second to fourth U-phase windings 111h to 111j.

The insulation paper sheet 112 is a member that electrically insulates radially adjacent joint portions from each other. As shown in FIG. 9, the insulation paper sheet 112 is bent into a meander form as shown in FIG. 10 by passing a belt-shape insulation paper sheet material 114 between toothed wheels G1 and G2 that rotate in mesh with each other. As shown in FIG. 11, the insulation paper sheet 112 is disposed in a meander layout between radially adjacent ones of the joint portions 111k to 111o that constitute the group of joint portions that is the nearest to the U-phase terminal TU, among groups of joint portions in each of which the joint portions are arranged in a direction of radius (radial direction). Besides, insulation paper sheets 112 are also disposed in the same layout between radially adjacent ones of the joint portions that constitute each of the group of joint portions that is the nearest to a V-phase terminal TV and the group of joint portions that is the nearest to a W-phase terminal TW.

Incidentally, surfaces of these joints adjacent to the meander insulation paper sheets 112 are not covered with an insulation resin. In contrast, surfaces of the joint portions other than those adjacent to the insulation paper sheets 112 are covered with an insulation resin 113.

The rotor 12 shown in FIG. 1 is a member that constitutes a part of the magnetic path, and that generates magnetic flux. The rotor 12 generates turning force due to the magnetic flux generated by the stator 11. The rotor 12 includes a rotor core 120, magnets, and a rotation axis/rotor shaft 121.

The rotor core 120 is a cylindrical member that constitutes a part of the magnetic path, and that is made of a magnetic material, and that holds the magnet 121. A center portion of the rotor core 120 is provided with a cylindrical through hole 120a. Besides, the magnets are fixed to an outer peripheral surface of the rotor core 120, and eight magnetic poles are formed. The rotor core 120 is rotatably housed in the through hole 110a of the stator core 110 so that outer peripheral surfaces of the magnets face the inner peripheral surface of the stator core 110 with an air gap provided therebetween.

A rotary shaft 121 is a generally cylindrical member made of a metal. The rotary shaft 121 fits into the through hole 120a of the rotor core 120, and is rotatably supported by the housing 10 via a bearing 121a.

Next, effects of this embodiment will be described. When voltage in a pulse form is applied to the stator winding 111 in order to drive the motor-generator 1, surge voltage occurs immediately following the application of the voltage. This surge voltage occurs because of the inductance of the stator winding 111. Therefore, the magnitude of the surge voltage varies depending on the location in each phase winding. Specifically, in the stator winding 111 constructed by the Y-connection of the U-phase winding 111c, the V-phase winding 111d and the W-phase winding 111e, the magnitude of the surge voltage gradually increases from a neutral point N toward each of the phase terminals TU, TV and TW.

By the way, the creepage distance between joint portions has to be made longer the greater the potential difference between the joint portions. Therefore, in the stator winding 111 constructed by the Y-connection of the U-phase winding 111c, the V-phase winding 111d and the W-phase winding 111e, the creepage distance between joint portions in each phase winding needs to be made longer the nearer to the phase terminal TU, TV or TW the joint portions are.

However, according to the first embodiment, as for the groups of the five joint portions that are the nearest to any one of the phase terminals TU, TV and TW, the insulation paper sheets 112 are disposed between radially adjacent ones of the groups, the interval or distance between the radially adjacent joint portions being relatively short. In contrast, as for the other joint portions, the potential difference between joint portions is relatively small, and the creepage distance does not need to be very long, and therefore, surfaces of these joint portions are covered with the insulation resin 113. That is, because the insulation paper sheets 112 are disposed between the joint portions that need long creepage distances and the insulation resin 113 is used to cover surfaces of the other joint portions, which do not need such long creepage distances, it is possible to simplify the construction and restrain the cost while securing necessary creepage distances.

Besides, according to the first embodiment, it suffices that the insulation paper sheets 112 are disposed only between adjacent joint portions that constitute the groups of joint portions that are the nearest to the corresponding phase terminals. Therefore, the assemble process can be simplified, and the cost can be further restrained.

Furthermore, according to the first embodiment, the insulation paper sheets 112 are bent in the meander bent form. Therefore, the insulation paper sheets 112 can be certainly disposed between the radially adjacent joint portions. Besides, since the insulation paper sheets 112 are disposed in the meander layout between the radially adjacent joint portions, it is possible to substantially prevent the insulation paper sheets 112 from falling apart from the joint portions in the circumferential direction.

In addition, according to the first embodiment, the insulation paper sheets 112 are formed by passing a belt-shape insulation paper sheet material 114 between the toothed wheels G1 and G2 that rotate in mesh with each other. Therefore, the insulation paper sheets 112 can be certainly formed in the meander form.

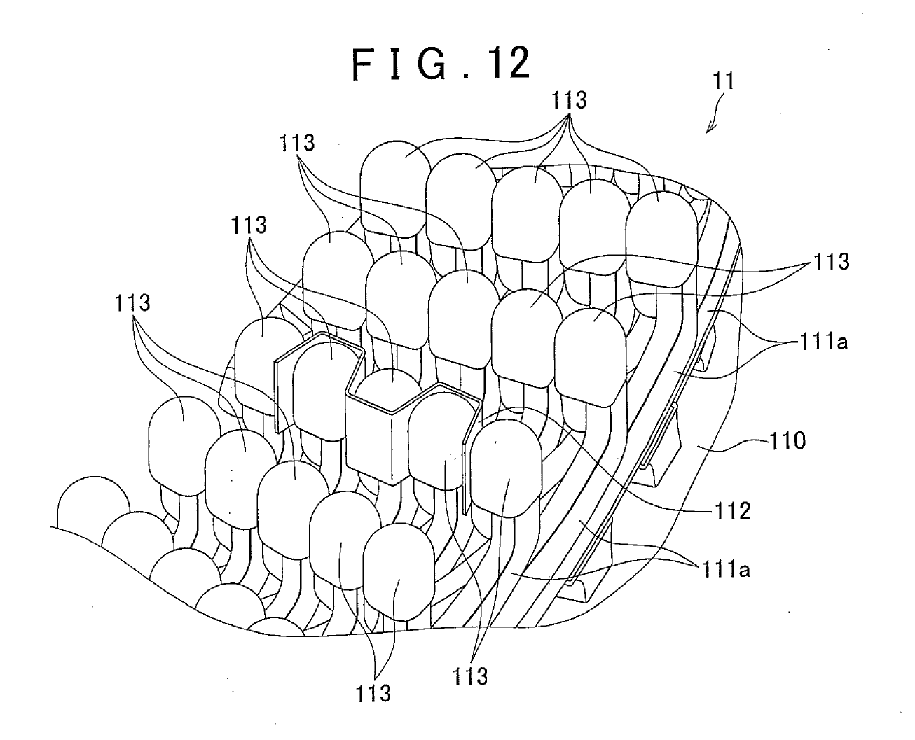

Incidentally, although in the foregoing description of the first embodiment, the surfaces of the joint portions of the groups of joint portions that are the nearest to any one of the phase terminals are not covered with the insulation resin 113, this construction is not restrictive. That is, the surfaces of these joint portions may also be covered with the insulation resin 113 in the same manner as the other joint portions. Besides, as shown in FIG. 12, the surfaces of these joint portions may be covered with the insulation resin 113 in addition to the insulation paper sheets 112 disposed between adjacent ones of these joint portions.

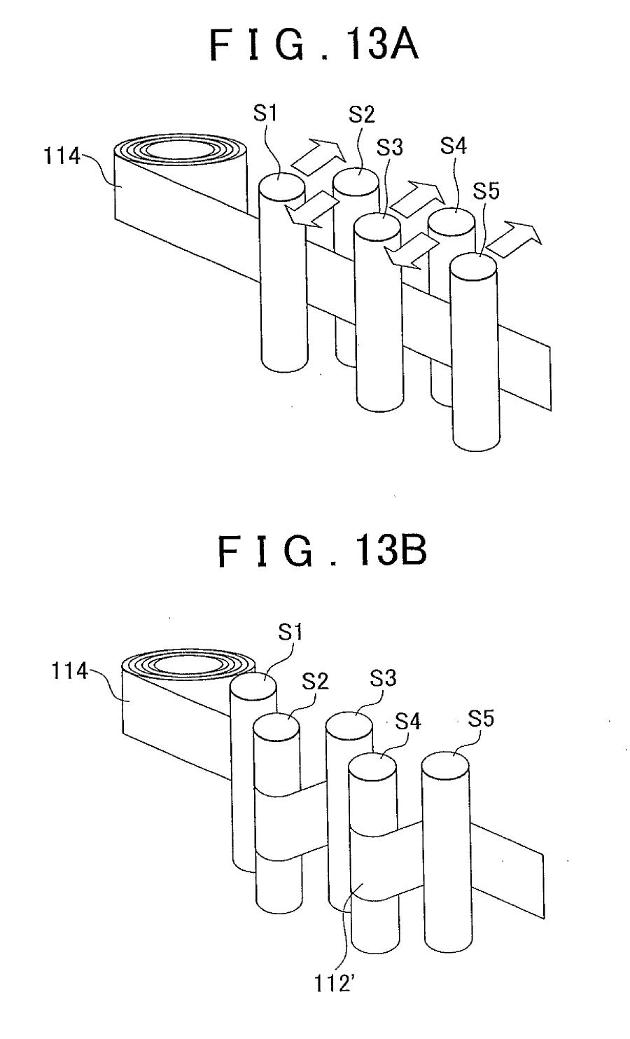

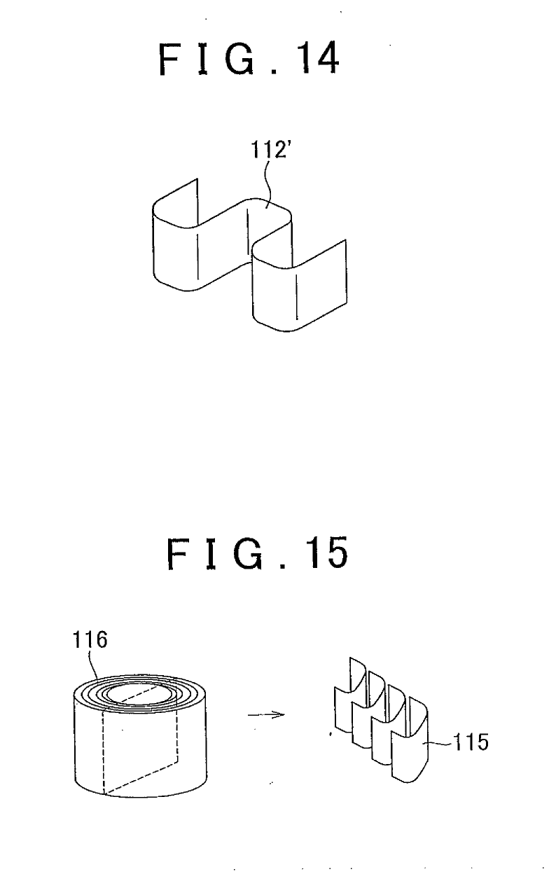

Besides, although in the foregoing description of the first embodiment the insulation paper sheets 112 are bent in the meander form by passing the belt-shape insulation paper sheet material 114 between the toothed wheels G1 and G2 that rotate in mesh with each other, this is not restrictive. For example, as shown in FIGS. 13A and 13B, a belt-shape insulation paper sheet material 114 may be disposed between two rows of rod-shape members S1 to S5 arranged in a zigzag manner, and the rod-shape members S1, S3 and S5 of one of the two rows may be relatively moved to the side of the rod-shape members S2 and S4 of the other row, so that the insulation paper sheet material 114 will be bent into a meander form as shown in FIG. 14.

Furthermore, although in the foregoing description of the first embodiment, the insulation paper sheets are disposed between adjacent ones of the five joint portions of each one of the groups of joint portions that are the nearest to the corresponding ones of the phase terminals, the number of the joint portions between which an insulation paper sheet is disposed is not limited to five. The number of joint portions between which an insulation paper sheet needs to be disposed may be determined by taking into account the potential differences between the joint portions.

In addition, although in the foregoing description of the first embodiment, the stator winding 111 is constructed by the Y-connection of the U-phase winding 111c, the V-phase winding 111d and the W-phase winding 111e, the number of phases is not limited to three. The invention is also applicable to a construction in which multi-phase windings of four or more phases are connected in a start connection form.

Next, a motor-generator in accordance with a second embodiment of the invention will be described. The motor-generator in accordance with the second embodiment, is different from the motor-generator in accordance with the first embodiment in that the insulation paper sheets bent in the meander form are replaced with U-shape insulation paper sheets.

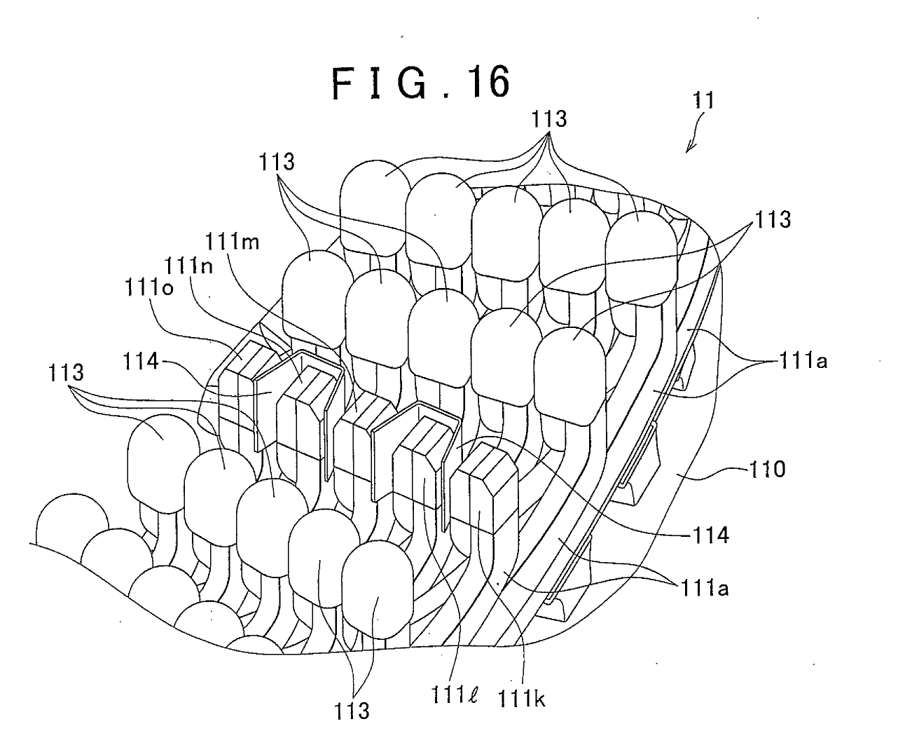

With reference to FIGS. 15 and 16, a construction of the motor-generator in the second embodiment will be described. FIG. 15 is an illustrative diagram for describing a process of bending insulation paper sheets in the second embodiment. FIG. 16 is a partial perspective view of a stator.

As shown in FIG. 15, the insulation paper sheets 115 are bent into an arcuate shape (generally letter U shape) by cutting an insulation paper sheet material 116 that is circularly wound in a roll, in the direction of an axis of the roll. As shown in FIG. 16, insulation paper sheets 114 are disposed between radially adjacent ones of joint portions 111k to 111o that constitute a group of joint portions that is the nearest to a U-phase terminal TU, among groups of joint portions that are disposed in directions of radius and that are connected to the U-phase terminal TU, in such a manner that the insulation paper sheets 114 surround side surfaces of the joint portions 111l and 111n. Besides, insulation paper sheets are also disposed between radially adjacent ones of the joint portions that constitute groups of joint portions each of which groups is the nearest to either a V-phase terminal TV or a W-phase terminal TW.

Next, effects of the second embodiment will be described. According to the second embodiment, the insulation paper sheets 114 are bent in the arcuate shape. Therefore, the insulation paper sheets 114 can be certainly disposed between the foregoing radially adjacent joint portions.

Besides, although in the second embodiment, the surfaces of the joint portions of the groups of joint portions that are the nearest to the corresponding ones of the phase terminals are not covered with the insulation resin 113, this construction is not restrictive. These joint portions may also be covered with the insulation resin 113 in the same manner as the other joint portions. Besides, the surfaces of these joint portions may also be covered with the insulation resin 113 in addition to the insulation paper sheets 114 disposed between the joint portions.

Besides, although in the second embodiment, the insulation paper sheets 114 are formed in an arcuate form by cutting the insulation paper sheet material 116 provided in a roll form in the direction of an axis of the roll, this is not restrictive. The insulation paper sheets may also be formed by cutting an insulation paper sheet material that is bent in the meander form by the method that is described above in conjunction with the first embodiment.

1. A stator for a rotary electric machine comprising:
a stator core that has a plurality of slots that extend from one end side of the stator core to another end side of the stator core; and
a stator winding constructed by forming a star connection of a plurality of phase windings that are constructed by inserting leg portions of a plurality of U-shape conductor segments into the plurality of slots from the one end side of the stator core, and joining distal end portions of the plurality of conductor segments which protrude from the other end side of the stator core, a plurality of joint portions formed by joining the distal end portions of the conductor segments of each of the phase windings being arranged in a circumferential direction and being sequentially arranged in a radial direction from a side that is relatively near to a corresponding one of phase terminals of the phase windings, and only a predetermined number of the joint portions in each phase winding that are nearest to the corresponding one of the phase terminals among the joint portions of the phase winding being provided with an electrical insulation paper sheet that is disposed between radially adjacent ones of the predetermined number of the joint portions.

2. The stator according to claim 1, wherein
surfaces of the joint portions other than the predetermined number of the joint portions in each phase winding that are the nearest to the corresponding one of the phase terminals are covered with an insulation resin.

3. The stator according to claim 1, wherein
surfaces of the predetermined number of the joint portions of each phase winding that are the nearest to the corresponding one of the phase terminals are covered with the insulation resin.

4. The stator according to claim 1, wherein
surfaces of the predetermined number of the joint portions of each phase winding that are the nearest to the corresponding one of the phase terminals are covered with the insulation resin besides the insulation paper sheet that is disposed between the radially adjacent ones of the predetermined number of the joint portions.

5. The stator according to claim 1, wherein
the predetermined number of the joint portions of each phase winding that are the nearest to the corresponding one of the phase terminals are the joint portions that constitute a group of joint portions arranged in a radial direction which is the nearest to the corresponding one of the phase terminals among a plurality of groups of radially arranged joint portions in each phase winding.

6. The stator according to claim 1, wherein
the insulation paper sheet has a generally U-shape form, and is disposed between the joint portions.

7. The stator according to claim 1, wherein
the insulation paper sheet has a meander form, and is disposed in a meander manner between the joint portions.

8. The stator according to claim 7, wherein
the insulation paper sheet is given the meander form by passing the insulation paper sheet between toothed wheels that rotate in mesh with each other.

9. The stator according to claim 7, wherein
the insulation paper sheet is given the meander form by disposing the insulation paper sheet between two rows of rod-shape members that are arranged in a zigzag manner, and then relatively moving one of the two rows of the rod-shape members to a side of another one of the two rows of the rod-shape members.

10. A rotary electric machine characterized by being constructed by using the stator according to claim 1.
